(19) United States
(12) Patent Application Publication
(10) Pub. No.: US 2006/0213725 A1
(43) Pub. Date: Sep. 28, 2006

(54) Lubricant distributor

(76) Inventors: Jorg Czempisz, Kempen (DE); Peter Clauss, Dusseldorf (DE); Ralf Kammel, Monheim (DE)

Correspondence Address: HARNESS, DICKEY & PIERCE, P.L.C., P.O. BOX 828, BLOOMFIELD HILLS, MI, 48303, US

(21) Appl. No.: 11/387,099

(22) Filed: Mar. 22, 2006

(30) Foreign Application Priority Data
Mar. 24, 2005 (DE) 20 2005 005 010.5

(51) Int. Cl. F16N 27/00

(52) U.S. Cl. 184/7.4

(57) ABSTRACT

A lubricant distributor in which the path of movement of a metering piston may be continuously determined by means of an entry body-coil assembly, whereby the entry body moves relative to the coil with movement of the metering piston. The current position of the metering piston may preferably be worked out in a computing unit. Means for indicating the current position of the metering piston can also be provided. With the aid of the invention, constant monitoring of the operation of a lubricant distributor and thus the detection of operational faults are possible in a continuous manner which may be centrally analysed. The conveyed volume, which is dispensed precisely at each lubrication or friction point, may be determined on each working stroke so that, in particular, insufficient lubrication and faulty lubrication may be avoided.

### BACKGROUND OF THE INVENTION

The invention relates to a lubricant distributor for dispensing lubricant at lubrication points including connectors for lubricant supply conduits and outlets to the lubrication points, at least one metering piston, which is movable within the lubricant distributor, being provided for dispensing and metering the lubricant.

Such lubricant distributors are known and fulfil the purpose of dispensing the lubricant in a metered manner at the lubrication points. They are produced in a modular construction with different metering volumes, whereby each lubricant distributor can have two respective threaded bores at its two end faces for the selective connection of the two main conduits of the central lubricating system. The lubricant distributor has, for instance, two to eight threaded bores for the connection of the lubrication point conduits.

The metering of the lubricant is effected by the respective metering piston, which is movably arranged in the lubricant distributor and dispenses a predetermined amount of lubricant on each stroke. The control of the metering piston is generally effected by a control piston, which can open and close the two main conduits. Depending on whether the pressure is applied to the first or the second main conduit, the control piston moves in one or other direction and thus opens one of the two main conduits, whereby the metering piston also moves and dispenses an appropriate amount of lubricant. The operating pressure can be up to 400 bar.

The function of the known distributors can be optically monitored by adjustment devices with movement indicators. The movement indicator is connected to the metering piston so that the reciprocating movements are visible from the exterior. Visual control is expensive, inaccurate and cannot be performed centrally.

In order to eliminate these disadvantages, an electric remote controller is known, in which the distributors are equipped with limit switches. An electrical pulse can be produced in the two end positions of the metering piston, which is used for the remote monitoring of the distributor function.

It has transpired in practice that the known remote monitoring is unsatisfactory. In particular, differences have arisen between the indicated metered volume and the volume of lubricant actually dispensed. Such a difference can be particularly disadvantageous if the amount of lubricant dispensed does not correspond to the necessary minimum amount for satisfactory lubrication of the friction points. This can result in destruction of the two components rubbing together.

Tests have shown that, in operation, incrustations occur and furthermore tolerance differences ensure that the volume of lubricant conveyed does not correspond to the value calculated from the end position of the metering piston. There is therefore a requirement to determine not only the end position of the metering piston but also to continuously monitor the movement path of the metering piston and preferably to achieve a continuous, central interrogation. This is where the invention intervenes.

It is the object of the invention to monitor the path of movement of a metering piston of a lubricant distributor of the type referred to above completely and not only the reaching of its end positions in order to be able to determine the precise position of the metering piston at all times.

The object is solved in accordance with the invention if the path of movement of the metering piston may be continuously determined by means of an entry body-coil assembly, whereby the entry body moves relative to the coil with movement of the metering piston. The current position of the metering piston may preferably be worked out in a computing unit. Means for indicating the current position of the metering piston can also be provided.

With the aid of the invention, constant monitoring of the operation of a lubricant distributor of the type referred to above and thus the detection of operational faults are possible for the first time in a continuous manner which may be centrally analysed. The conveyed volume, which is dispensed precisely at each lubrication or friction point, may be determined on each working stroke so that, in particular, insufficient lubrication and faulty lubrication may be avoided.

A voltage altering with time, for instance, particularly a harmonic, for instance sinusoidal, alternating voltage can be applied to the coil. A pulsed voltage is equally possible as the voltage changing with time. When a voltage is applied, the current is measured and the induction calculated by means of Ohm's Law. It is alternatively proposed that a current varying with time be applied and the voltage measured.

The entry body can be a metal core with magnetic and/or electrically conductive properties. If the magnetic entry body moves into the magnetic field produced by the coil, the inductivity increases, which permits conclusions to be made about the actual position of the piston. It is alternatively possible to use a magnetically permeable material for the entry body, which is not electrically conductive. Ferrite is referred to only by way of example.

The relationship between the measured inductivity and the path of movement or the actual position of the piston can be determined by means of a characteristic curve. This characteristic curve is dependent on the material used and the geometry of the coil and entry body. Alternatively, the calculation of the path is also possible in accordance with a formula, though such a formula is considerably more complex than the characteristic curve solution.

The coil is arranged as close as possible to the (largest) external diameter of the entry body. This ensures the largest possible interaction between the coil and the entry body.

The entry body is advantageously releasably connected to the metering piston. This permits not only simple assembly of the lubricant distributor in accordance with the invention but, under certain circumstances, also retrofitting to conventional lubricant distributors. This applies, in particular, if the entry body is arranged in axial extension of the metering piston and is connected to the metering piston by a peg. The peg extends the metering piston conveniently to a point outside the actual lubricant distributor housing and enables the position of the metering piston to be determined in accordance with the invention in a simple and precise manner. Every movement of the metering piston is thus transmitted to the entry body without any mechanical gearing.

In order to protect the coil and the entry body and to protect people against electric shocks, a coil housing can be provided, in which the coil is disposed. Such a coil housing protects the interior not only against mechanical influences but also against other environmental influences, such as the lubricant itself.

It is proposed in an important embodiment of the invention that the windings of the coil are moulded in the coil housing. As already mentioned, the coil assembly is disposed as closely as possible to the entry passage for the entry body. The coil housing can consist of plastic material and accommodate further components, such as a function indicator (LED). Overall, as a result of the use of a coil housing with an integrated coil and optionally further components, a compact, integral and, above all, insensitive construction is produced. The material of the coil housing is furthermore so selected that it has as small as possible an influence on the magnetic field which is produced.

The coil housing is conveniently releasably connected to the lubricant distributor. In an advantageous construction, the coil housing is releasably connected to an adapter piece, the adapter piece also being releasably connected to the lubricant distributor or the housing of the lubricant distributor. The adapter piece can be constructed, for instance, in the form of a screw body and has a central opening through which the peg connecting the entry body to the metering piston may pass. The coil housing is preferably inverted over the other end of the screw body and secured by means of a setscrew. The aforementioned construction is not only particularly advantageous from the point of view of simple construction and simple assembly and disassembly but also with regard to simple retrofitting of existing conventional lubricant distributors.

The entry body is preferably of frustoconical shape, at least in one section. This has a positive effect on the characteristic curve and results, in particular, in the characteristic curve extending substantially linearly over the stroke, when plotting the inductivity. The conicity of the entry body also results in a slower rise in the inductivity over the first section of the movement path of the metering piston.

The precise determination of the amount of lubricant transmitted to the friction point is possible for the first time with the distributor in accordance with the invention, even if, for example as a result of certain pressure conditions in the central lubricating system, the metering piston has only covered a distance of three-quarters or the like of its total travel to its reversal point. This has the consequence that a transfer of lubricant has taken place but the entire amount provided has not been dispensed at the friction point. The extent of each lubrication process may thus be determined with the distributor in accordance with the invention and operational faults may be detected in a simple manner.

Further details, features and advantages of the subject matter of the invention will be apparent from the following description of the associated drawings, which show the following:

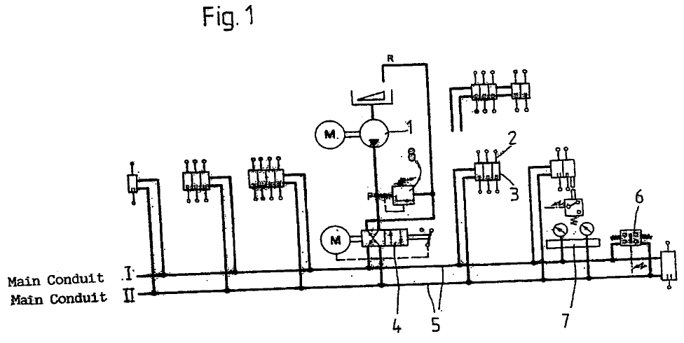

FIG. 1: A two conduit central lubricating system for grease or oil in a schematic view;

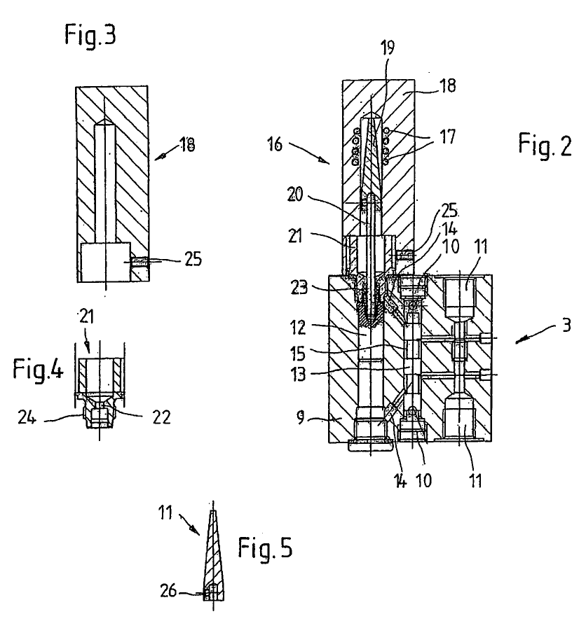

FIG. 2: A lubricant distributor in accordance with the invention for a system as shown in FIG. 1 in a sectional view;

FIG. 3: The coil housing on its own of the lubricant distributor in accordance with the invention shown in FIG. 2;

FIG. 4: The adapter piece shown alone of the lubricant distributor of FIG. 2 and

FIG. 5: The immersion body shown alone of the lubricant distributor of FIG. 2.

Central lubricating systems as shown in FIG. 1 of the drawings with main conduits I and II serve to lubricate machines and machine systems with a large number of friction points. They consist essentially of a pump 1, a 4/2-way or 2, 3/2-way reversing valves 4, the two main conduits 5, the distributors 3 mounted in the vicinity of the friction points, the friction point conduits 2 leading to the friction points, a switching device 6 at the end of the conduit, a manometer bracket 7 and a controller. The pump is protected from excessive pressures by a pressure limiting valve 8.

The metered amount can be matched to the different lubricant requirements of the friction points by selecting a suitable size of distributor and by altering the metered volume adjustment and/or altering the pause time.

In such two conduit systems, the distributors 3 have the task of dispensing the lubricant in a precisely metered manner, independent of the backpressure, into the lubricant conduits leading to the friction points. They have connections for the main conduits, that is to say the lubricant supply conduits 5, and up to eight outlets, to which the friction point conduits 2 leading to the friction points are connected. Provided in each distributor 3 is at least one metering piston with a control piston connected upstream of it, as will be described in more detail below in conjunction with FIG. 2.

Such a distributor 3, equipped in accordance with the invention, is illustrated in FIG. 2 as a possible exemplary embodiment. The lubricant distributor 3 includes a lubricant distributor housing 9, which is of modular construction. Formed at the ends are two respective threaded bores 10 for connecting the two main conduits 5 and two (to eight) threaded bores 11 for connecting the friction point conduits 2, which are consequently the outlets I and II of the illustrated distributor.

Disposed within the interior of the housing 9 for the illustrated two connected friction points there are a metering piston 12 and a control piston 13, the cylinder spaces of which communicate with one another through control lines 14. The mode of operation is as follows:

During the lubrication pause, both pistons 12, 13 are in their lower end position. As soon as the main conduit I is pressurised and the main conduit II is simultaneously depressurised, the control piston 13 moves first and subsequently the metering piston 12 in an upward direction, whereby the volume of lubricant displaced by the metering piston 12 is forced via an annular groove 15 in the control piston 13 to the upper outlet II. The volume of lubricant displaced by the control piston 13 flows into the depressurised main conduit II.

In the second lubricating cycle, the main conduit II is pressurised and the main conduit I depressurised. The control piston 13 is thus moved firstly and then the metering piston 12, whereby the volume of lubricant displaced by the metering piston 12 is forced into the lower outlet I.

In order to regulate the mode of operation of the distributor 3, an entry body-coil assembly 16 is connected to the cylinder space of the metering piston 12, with which the path of movement of the metering piston 12 may be continuously detected. The metal body-coil assembly 16 includes a coil 17, shown schematically, which is embedded in a coil housing 18, and also an entry body 19, which is connected by means of a peg 20 to the metering piston 12 and moves up and down with the movement of the metering piston 12 in the housing 18 and, in particular, when the metering piston 12 moves upwardly, moves into the magnetic field of the coil produced when a voltage is applied to the coil. The coil 17 in the illustrated exemplary embodiment is a coiled wire. It can also be constructed in the form of a slotted sleeve. The entry body is formed in the present case of a magnetic steel. It can also, for instance, be formed of another magnetically permeable material or of a magnetically impermeable material, e.g. copper. In the illustrated exemplary embodiment, it is of frustoconical shape, whereby such shape of the entry body has an effect on the characteristic curve. The frustoconical target alters the resonant circuit, the detuning of which forms the basis of the analysis. A cylindrical entry body can of course equally be used.

The peg 20 extends out of the lubricant distributor housing 9 through an adapter piece 21. For this purpose, the adapter piece 21 has a central bore 22 (see also FIG. 4), which is sealed with respect to the cylinder space of the metering piston 12 by means of a seal 23. In its lower section, the adapter piece 21 has an external screwthread 24, with which it may be screwed into a corresponding internal screwthread on the lubricant distributor housing. The upper section is of substantially cylindrical shape and services to receive the housing 18, which may be secured to the adapter piece by means of a setscrew 25 (see also FIG. 3). The adapter piece 21 and the housing 18, which may be placed on it, and the connection of the entry body 19 to the metering piston 12 by means of the peg 20 not only permit the entire system to be taken apart and put together very simply, for instance for examination purposes. Simple retrofitting to existing conventional lubricant distributors is also possible.

The entry body 9 is also releasably connected to the connecting peg 20. For this purpose, it may be placed on the peg 20 and fixed in position by means of a setscrew 26 (see also FIG. 5).

Modifications of the inventive concept are of course possible within the scope of the inventive concept. Thus the invention is not necessarily limited to a lubricant distributor with a metering piston and control piston. It is instead important that the path of movement of the metering piston 12 be rendered detectable by means of an entry body-coil assembly. The metal body is of frustoconical shape in the particular exemplary embodiment. Other shapes are also possible over and above the cylindrical shape already mentioned. It is, in particular, also possible to construct the entry body for its part in the form of a coil body. The entry body can also be secured to the peg by means of adhesive or screwing. The same applies to the connection of the peg 20 to the metering piston 12. The adapter piece 21 need not necessarily fulfil two functions, namely guiding the peg 20 with respect to the exterior on one hand and receiving the housing 18 on the other hand. The housing 18 can also be connected directly to the lubricant distributor housing 9, even though the illustrated shape and function of the adapter piece are considered to be particularly advantageous. This applies, above all, if, as is not visible in the drawing, a plurality of housings are arranged adjacent to one another. The setscrew 25 then permits the housing 18 to be simply laterally connected to the adapter piece 21.

The entire disclosure of German Utility Model Application No. 20 2005 005 010.5 filed Mar. 24, 2005 is incorporated by reference.

What is claimed is:

1. A lubricant distributor (3) for dispensing lubricant at lubrication points including connections for lubricant supply conduits and outlets to the lubrication points, comprising:
at least one metering piston, which is movably arranged in the lubricant distributor, being provided for dispensing and metering the lubricant, characterised in that the path of movement of the metering piston (12) may be continuously determined by means of an entry body-coil assembly (16), whereby the entry body (19) moves relative to the coil (17) with the movement of the piston.

2. A lubricant distributor as claimed in claim 1 wherein the current position of the metering piston (12) may be calculated in a computing unit.

3. A lubricant distributor as claimed in claim 1 wherein the entry body (19) is releasably connected to the metering piston (12).

4. A lubricant distributor as claimed in claim 1 wherein the entry body (19) is arranged in an axial extension of the metering piston (12) and is connected to the metering piston by means of a peg (20).

5. A lubricant distributor as claimed in claim 1 wherein the coil (17) is disposed in a housing (18).

6. A lubricant distributor as claimed in claim 5 wherein the windings of the coil (17) are moulded into the housing (18).

7. A lubricant distributor as claimed in claim 5 wherein the coil housing (18) is releasably connected to the lubricant distributor (3).

8. A lubricant distributor as claimed in claim 5 wherein the coil housing (18) is releasably connected to an adapter piece (21) and that the adapter piece is releasably connected to the lubricant distributor.

9. A lubricant distributor as claimed in claim 1 wherein
the entry body (19) is of frustoconical shape in at least one section.
